(19) United States
(12) Patent Application Publication
(10) Pub. No.: US 2013/0124071 A1
(43) Pub. Date: May 16, 2013

(54) METHOD FOR OPERATING A START-STOP SYSTEM OF A MOTOR VEHICLE, AND A MOTOR VEHICLE

(71) Applicant: Audi AG, Ingolstadt (DE)

(72) Inventor: Sebastian Engel, Ingolstadt (DE)

(73) Assignee: Audi AG, Ingolstadt (DE)

(21) Appl. No.: 13/665,619

(22) Filed: Oct. 31, 2012

(30) Foreign Application Priority Data
Nov. 11, 2011 (DE) 10 2011 118 252.0

(51) Int. Cl. F02D 28/00

(52) U.S. Cl. 701/112

(57) ABSTRACT

A method for operating a start-stop system of a motor vehicle, which is configured for turning of the engine the motor vehicle off in a standstill phase of the motor vehicle, wherein upon detecting traffic congestion, movement state information is received from additional road users located in front of the motor vehicle via the wireless communication device, the received movement state information is evaluated and used to determine therefrom congestion information describing dissipation and/or a movement phase of the traffic congestion. The engine is then automatically started and/or a message is outputted to the driver based on the determined congestion information.

### CROSS-REFERENCES TO RELATED APPLICATIONS

This application claims the priority of German Patent Application, Serial No. 10 2011 118 252.0, filed Nov. 11, 2011, pursuant to 35 U.S.C. 119(a)-(d), the content of which is incorporated herein by reference in its entirety as if fully set forth herein.

### BACKGROUND OF THE INVENTION

The present invention relates to a method for operating a start-stop system of a motor vehicle which is configured for turning the engine of the motor vehicle off in a standstill phase of the motor vehicle, and a motor vehicle with a start-stop system.

The following discussion of related art is provided to assist the reader in understanding the advantages of the invention, and is not to be construed as an admission that this related art is prior art to this invention.

Start-stop systems for motor vehicles are nowadays widely known and are also installed in mass-produced vehicles. With these systems, the engine of the motor vehicle is turned off in standstill phases, for example when the motor vehicle waits at a traffic signal or is stopped in traffic and the driver did not engage a gear. With the conventional start-stop systems, the engine is restarted in response to an operation by the driver. For example, the clutch pedal must be operated or a gear engaged (a driving stage) as a prerequisite for restarting the engine

In particular, such approach is disadvantageous in traffic jams and similar traffic situations, because of the driver is unable to directly view a dissipation of the congestion and/or movement phases within the congestion, so that the engine is frequently only restarted when the road user directly in front of the own motor vehicle begins to move again. As a result, the entire process of “starting again” is unnecessarily prolonged and congestions are dissipated more slowly or prolonged due to a slower advance within the congested area, and the like.

It would therefore be desirable and advantageous to obviate prior art shortcomings and to improve the operation of a start-stop system so as to optimize the timing of a restart in a congested traffic situation.

### SUMMARY OF THE INVENTION

According to one aspect of the present invention, a motor vehicle includes start-stop system configured to turn the engine of the motor vehicle off when the motor vehicle is standing still. A method for operating the start-stop system of includes the steps of detecting traffic congestion, receiving movement state information from additional road users located in front of the motor vehicle via at least one wireless communication device, evaluating the received movement state information and determining therefrom congestion information describing dissipation of the traffic congestion and/or movement of the traffic congestion, and—based on the determined congestion information—automatically starting the engine and/or outputting a message to the driver.

The present invention thus proposes to use a vehicle-to-vehicle communication (car2car communication) for analyzing the traffic situation and for accordingly optimize the operation of the start-stop system. For this purpose, the method according to the invention may, for example, be carried out in a control device of the start-stop system. Movement state information (movement profiles) of surrounding vehicles and/or road users are wirelessly received via a communication device associated with the vehicle-to-vehicle communication and evaluated with respect to the actual situation. Advantageously, all surrounding road users may be configured for vehicle-to-vehicle communication, so that the movement state information of all road users located in front of the vehicle in the lane of the vehicle within the communication range can be received and evaluated. If not all motor vehicles are configured for vehicle-to-vehicle communication, then the congestion information may advantageously be determined by evaluating the movement state information of all road users configured for vehicle-to-vehicle communication and located in front of the motor vehicle in the lane of the motor vehicle within the communication range. It should here be mentioned that the own motor vehicle is also able to transmit movement state information that can be used by other road users, wherein the movement state information can also be evaluated for other purposes. Of course, the congestion situation itself may also be detected by evaluating the movement state information of the other road users, in particular the road users located in front of the motor vehicle in the same lane as the motor vehicle.

Within the context of the method of the invention, an intervention may be made in situations where the start-stop system has turned the engine off due to a stop in a traffic jam. The control device identifies the movement profiles of the motor vehicle in its environment based on the vehicle-to-vehicle communication. When it is recognized during evaluation of the movement state information, for which for example suitable algorithms and/or hardware components in the control device of the start-stop system may be provided, that many other road users transition from a stopped state to a moving state in a specific projected location or future time, in particular in a correlated manner, then a dissipation of the congestion and/or a movement phase of the congestion may be detected, so that corresponding measures can be taken that will result in an earlier startup of the engine.

According to another advantageous feature of the present invention, the engine may be restarted preventatively, for example when satisfying a specific condition evaluating the congestion information, in order to start moving again as quickly as possible, thereby minimizing the time for a dissipation of the congestion and/or a transition into the movement phase. Alternatively or in addition, a message may be outputted for the driver relating to the dissipation and/or movement phase of the congestion, so that the driver, if the engine cannot be restarted automatically, can take suitable measures to get moving again as quickly as possible and to thus optimize the timing. The engine is therefore started based in response to an operation from the driver not only when the vehicle in front begins to move, but the engine may instead be restarted earlier in response the operation, thus reducing the time for moving again and dissipating the congestion.

According to another advantageous feature of the present invention, the vehicle may be started up quickly and without significant delay by preventatively restarting the engine of the motor vehicle, in particular automatically. This reduces the overall time required for dissipating the congestion and/or for transitioning into the movement phase. By starting the engine and/or as a result of the message, the attention of the driver is also directed to the traffic situation, so that the driver can be psychologically and physically prepared to continue the trip.

According to another advantageous feature of the present invention, the position and/or the speed of an approach point located in front of the motor vehicle may be determined as congestion information. When vehicles standing in line start to move one after the other starting with the vehicle in front, a virtual point may be detected, where the motor vehicles transition from standstill to the moving state, i.e. an approach point. The position and the time evolution of the approach point can then be determined by analyzing the movement state information, which may include particularly a speed and a position. The approach point will typically move towards the motor vehicle at a substantially constant speed.

According to another advantageous feature of the present invention, a condition for starting the engine and/or outputting the information may be, for example, when the distance of the approach point from the own vehicle becomes less than a threshold value that depends in particular from the speed of the approach point, i.e. essentially two embodiments may be envisioned. For example, the method may include restarting the engine (or outputting the message) when the approach point is located at a fixed distance from the motor vehicle. However, it would also be advantageous within the context of the invention to also take into consideration the speed of the virtual approach point, which will be assumed to be constant from there on. With the assumption of a constant speed of the virtual approach point in the direction of the own motor vehicle, the engine may be started with at a specific earlier time (TTS—time to start). When the start time of the engine or the output of the message in the first variant depends solely from the distance of the congestion dissipation, i.e. in general from the distance of the virtual approach point, then the velocity of the congestion dissipation, in general the velocity of the approach point, also enters the picture.

According to another advantageous feature of the present invention, a speed and/or a position and/or an acceleration may be received as the movement state information. Within the context of the present invention, the position may be analyzed in any manner; for example, the position information may also include lane information, in particular from multilane roads with traffic congestion. Otherwise, positions may be represented, for example, based on GPS coordinates, map data and/or as the relative position to the own vehicle. An actual speed or an actual acceleration may be processed within the context of the present invention, wherein the aforementioned possible movement state information may, of course, also be transmitted via vehicle-to-vehicle communication for use in other vehicle systems.

As mentioned above, the communication device may advantageously be a vehicle-to-vehicle communication device. Advantageously, the range of the communication may be greater than 50 m, in particular greater than 100 m. The position and optionally speed of the approach point can be determined with greater accuracy when the movement state information can be obtained from farther ahead. Optionally, a determination can also be made whether this is a movement phase within a traffic congestion or the traffic congestion is dissipating. It should be mentioned in this context that the movement state information may also be transmitted beyond the actual range of the communication by way of “hopping”, with motor vehicles forwarding received movement state information to other road users. Vehicle-to-vehicle communication already uses standards, for example the WLAN 802.11p standard, which may then also be used for actual communication networks or communication links

According to another advantageous feature of the present invention, the message may be outputted optically and/or acoustically and/or haptically, in particular via a head-up display. Different types of messages may be contemplated to direct the attention of the driver to the approaching approach point or to the fact that the engine has been started automatically. Optical displays, which may for example also display the position and/or speed of the approach point in form of a graphic representation, are hereby preferred, so that the driver receives an indication in spite of that fact that vehicles located directly in front obscure the field of view when the traffic starts to move again or the congestion dissipates. For example, the own lane and the road users in front may be displayed in form of an abstract representation which is displayed together with an overlaid line marking the approach point or with a representation of the approach point and its temporal evolution.

According to another aspect of the invention, the invention is also directed to a motor vehicle, with a communication device for communication with other road users and a start-stop system with a control device configured for carrying out the method according to the invention. The entire description relating to the method of the invention can similarly be applied to the motor vehicle of the invention, so that the aforementioned advantages can also be attained.

According to a advantageous feature of the present invention, movement state information may be received from other road users via the communication device, which may then transmitted be also to the control device, for example via a bus system, in particular a CAN bus. The movement state information may initially be pre-filtered, so that only road users in the same lane as the particular motor vehicle and located in front of the particular motor vehicle are taken into consideration in the further analysis. The control device is then configured to determine the congestion information from the movement state information, for example, for determining the position and optionally the speed of an approach point located in front of the motor vehicle; the congestion information may then be further evaluated with respect to a criterion, for example the aforedescribed threshold value. If the criterion is satisfied, the engine of the motor vehicle is controlled to start up again and/or the display device is controlled to output the message.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic diagram of a motor vehicle according to the present invention,

FIG. 2 is a diagram for defining an approach point, and

FIG. 3 is a possible representation of information and for outputting a message to the driver.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

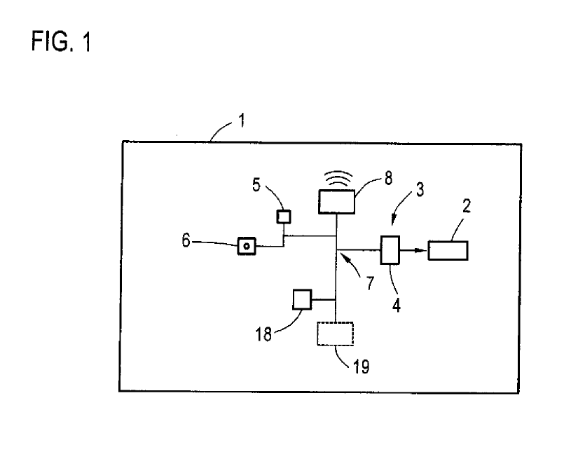

Turning now to the drawing, and in particular to FIG. 1, there is shown a schematic diagram of a motor vehicle 1 according to the invention. The motor vehicle 1 includes, as generally known, an engine 2, in the present example a conventional internal combustion engine. A start-stop system 3 with a control device 4 is configured to turn the engine 2 off when the motor vehicle is at a standstill, for example in a traffic congestion. The start-stop system 3 can be informed by way of a specific operation, for example by depressing a clutch pedal 5 and by engaging a gear via the gear selection lever 6, that the engine 2 should be restarted.

Because the driver is frequently only able to realize in a traffic congestion that he must begin to move again when the road user in the same lane directly in front of him starts to move, time delays occur. To prevent such time delays, the control device 4 is configured to perform the method according to the invention. The control device 4 is hereby connected via a bus system 7 in particular also with a communication device 8 for the vehicle-to-vehicle communication (car2car communication).

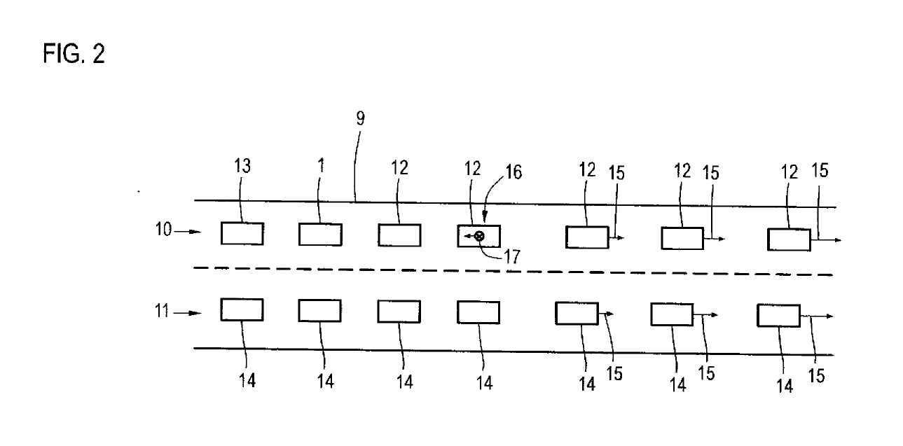

The communication device 8 may hereby receive information from other road users up to a distance of 100 m or more, in particular also movement state information of other road users. This received movement state information may be evaluated in the control device 4, in the present situation, on one hand, for fundamentally detecting a congestion in which the motor vehicle 1 is located and, on the other hand, to also determine from the received movement state information congestion other information describing a dissipation and/or movement phase of the traffic congestion. The received movement state information is hereby initially filtered, so that only those road users are considered which are located in front of the own motor vehicle 1 and in the same lane as the own motor vehicle 1, which will be described in more detail with reference to the diagram in FIG. 2.

FIG. 2 shows a road 9 with two lanes 10 and 11 open for travel in the same direction. The motor vehicle 1 is here in the left lane 10. Only the road users 12 driving in front of the motor vehicle in lane 10 are relevant for evaluating the presence of a movement phase or a dissipation of the congestion. Road users 13 behind the vehicle 1 or road users 14 on the adjacent lane 11 are not taken into consideration, i.e., their movement state information does not enter the computations for determining the congestion information.

The movement state information includes, in addition to the position of the respective road users 12, 13, 14 which also includes the lane 10, 11 of the road users 12, 13, 14, also the actual speed which is indicated in FIG. 2 by the arrows 15. The actual acceleration may also be included in the movement state information. The motor vehicle 1 also transmits its own movement state information via the communication device 8.

Is obvious that the congestion is already dissipating in the situation illustrated in FIG. 2, i.e. the road users 12, 14 shown on the right side of FIG. 2 already move at a certain speed. One of the road users 12, here the vehicle 16 in lane 10 of the motor vehicle 1, is just beginning to move. A virtual approach point 17 can now be defined which in this case is located at the vehicle 16. By considering in particular also the time dependence of the movement state information, the control device 4 is not only able to determine the actual position of the approach point 17, but also its speed which should be essentially constant. This position and speed of the approach point 17 are now evaluated in the illustrated exemplary embodiment based on a condition in order to decide whether the engine 2 should be automatically started or whether a corresponding optical, acoustic and/or haptic signal should be outputted to the driver which would allow the driver to physically and psychologically prepare for the impending start-up process.

The present example, a speed-dependent threshold value for the distance of the approach point 17 from the motor vehicle is determined under the assumption that the speed of the virtual approach point 17 can be assumed to be constant, wherein for example the actually determined value for the speed of the approach point 17 or an averaged value for the speed of the approach point 17 can be used. If it turns out that the actually determined distance of the approach point 17 from the motor vehicle 1 is less than this threshold value, then the engine 2 is restarted and the aforedescribed message is displayed via a suitable display device 18, to which the control device 4 is also connected by way of the bus system 7. It should be mentioned here that additional vehicle systems 19 may also be connected to the bus system 7.

It should be further mentioned that within the context of the invention information may be continuously passed on to the driver of the motor vehicle 1 by bringing to the attention of the driver the via the display device congestion information, in this case information relating to the virtual approach point.

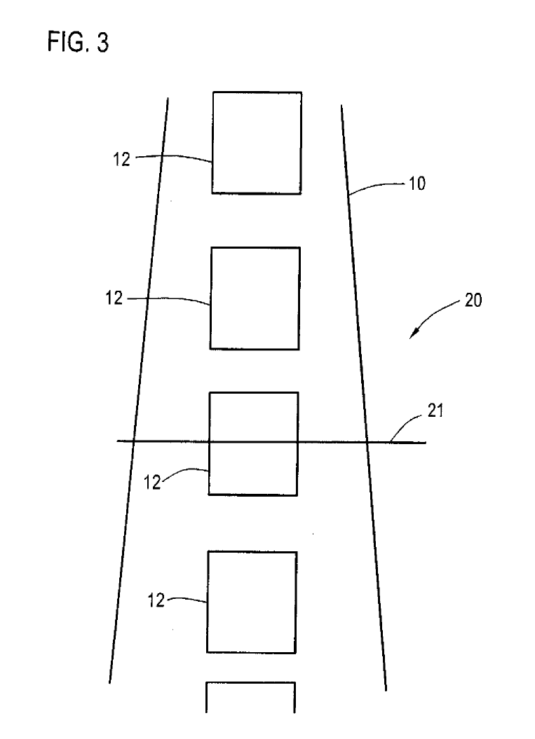

FIG. 3 shows a possible diagram 20 relating depicting this situation, showing schematically the own lane 10 with the only schematically indicated road users 12. The actual position of the approach point 17 is indicated by a bar 21 which is continuously updated.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for operating a start-stop system of a motor vehicle, wherein the start-stop system is configured to turn an engine of the motor vehicle off in a standstill phase of the motor vehicle, the method comprising the steps of:
detecting traffic congestion,
receiving movement state information from additional road users located in front of the motor vehicle via at least one wireless communication device,
evaluating the received movement state information and determining therefrom congestion information describing at least one of a dissipation and a movement phase of the traffic congestion, and
based on the determined congestion information, at least one of automatically starting the engine and outputting a message to the driver.

2. The method of claim 1, wherein the determined congestion information includes at least one of a position and a speed of an approach point located in front of the vehicle.

3. The method of claim 2, wherein the engine is started or the message is outputted when a distance of the approach point from the vehicle is less than a threshold value.

4. The method of claim 3, wherein the threshold value depends on the speed of the approach point.

5. The method of claim 1, wherein the received movement state information comprises at least one of a speed, a position and an acceleration.

6. The method of claim 1, wherein the at least one wireless communication device is a vehicle-to-vehicle communication device.

7. The method of claim 6, wherein the vehicle-to-vehicle communication device has a range of greater than 50 m.

8. The method of claim 7, wherein the vehicle-to-vehicle communication device has a range of greater than 100 m.

9. The method of claim 1, wherein the message is outputted optically, acoustically or haptically, or by a combination thereof.

10. The method of claim 9, wherein the message is outputted via a head-up display.

11. A motor vehicle, comprising:
a communication device configured for vehicle-to-vehicle communication between the motor vehicle and other road users, and
a start-stop system configured to turn an engine of the motor vehicle off in a standstill phase of the motor vehicle,
wherein the start-stop system comprises a control device configured to:
upon detecting traffic congestion, receive movement state information from additional road users located in front of the motor vehicle via the wireless communication device,
evaluate the received movement state information and determine therefrom congestion information describing at least one of a dissipation and a movement phase of the traffic congestion, and
based on the determined congestion information, at least one of automatically start the engine and output a message to the driver.
